(19) United States
(12) Patent Application Publication
(10) Pub. No.: US 2025/0217638 A1
(43) Pub. Date: Jul. 3, 2025

(54) METHODS AND SYSTEMS FOR SPEECH EMOTION RETRIEVAL VIA NATURAL LANGUAGE PROMPTS

(71) Applicant: Robert Bosch GmbH, Stuttgart (DE)

(72) Inventors: Wei-Cheng Lin, Pittsburgh, PA (US); Ho-Hsiang Wu, Morrisville, NC (US); Shabnam Ghaffarzadegan, Livermore, CA (US); Luca Bondi, Pittsburgh, PA (US); Abinaya Kumar, Pittsburgh, PA (US); Samarjit Das, Wexford, PA (US)

(21) Appl. No.: 18/400,584

(22) Filed: Dec. 29, 2023

(51) Int. Cl. G06N 3/08; G10L 15/06; G10L 15/183; G10L 15/30; G10L 25/63

(52) U.S. Cl. CPC G06N 3/08; G10L 15/063; G10L 15/183; G10L 15/30; G10L 25/63

(57) ABSTRACT

Methods and systems for generating training data for training a contrastive language-audio machine-learning model. A plurality of audio segments are retrieved from a speech emotion recognition (SER) database along with metadata associated with the audio segments. The metadata of each audio segment includes an emotion class. Words or terms associated with emotions are retrieved from a lexicon. A large language model (LLM) is executed on (i) the classes of emotion associated with the audio segments and (ii) the words or terms from the lexicon. This generates a plurality of text captions associated with emotion, which are stored in a caption pool. For each audio segment retrieved from the SER database, that audio segment is paired with one or more of the text captions from the caption pool that were generated based on the emotion class associated with that audio segment. This yields audio-text pairs for training a contrastive learning model.

### TECHNICAL FIELD

The present disclosure relates to methods and systems for speech emotion retrieval via natural language prompts. Embodiments of this disclosure include methods and systems for training a contrastive learning model based on audio and text.

### BACKGROUND

The human auditory system can hear sounds and extract the kind of decisions or meanings we need to interact with our surroundings. For example, if we are in a soccer game and suddenly hear the crowd cheering joyfully, we can assume the local team scored. Computer models aim to understand audio cues by automatically processing audio signals and extracting meaning. Mainstream machine learning models break the human hearing into tasks, such as the classification of sound events and acoustic scenes. Such models are trained by associating audio recordings to class labels of predefined categories for a specific task and can only predict specific categories. Learning under such restricted supervision limits the flexibility to predict unseen classes or out-of-domain (OOD) acoustic conditions.

### SUMMARY

In an embodiment, a method for generating training data for training a contrastive language-audio machine-learning model is provided. The method includes: retrieving a plurality of audio segments from a speech emotion recognition (SER) database and metadata associated with the audio segments, wherein the metadata of each audio segment includes a class of emotion associated with that audio segment: retrieving words or terms associated with emotions from a lexicon: executing a large language model (LLM) on (i) the classes of emotion associated with the audio segments and (ii) the words or terms from the lexicon, wherein the execution of the LLM generates a plurality of text captions associated with emotion: storing the plurality of text captions in a caption pool: for each audio segment retrieved from the SER database, pairing that audio segment with one or more of the text captions from the caption pool that were generated by the LLM based on the class of emotion associated with that audio segment, wherein the pairing yields audio-text pairs; and training a contrastive learning model using the audio-text pairs.

In another embodiment, a system including a processor and memory containing instructions that, when executed by the processor, cause the processor to perform these steps.

In another embodiment, a non-transitory computer-readable medium includes instructions that, when executed by a processor, cause the processor to perform these steps.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a schematic overview of a contrastive learning model, according to an embodiment.

FIG. 4 shows a schematic overview of a system for generating data for a contrastive learning model and training the model, according to an embodiment.

FIG. 5 shows a table of generated captions utilizing the system of FIG. 4, according to an embodiment.

FIG. 6 shows a method of generating data for a contrastive learning model and training the model, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale: some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

As a crucial part in human-machine interaction, speech emotion recognition (SER) has garnered widespread attention of researchers cross academia and industry. Over the previous decade, with tremendous progress of deep learning techniques, numerous deep neural network (DNN) based SER methods have been proposed and achieved better performance compared with traditional SER methods. However, the SER field still faces a critical issue of a lack of sufficient available dataset, since collecting and annotating speech emotion data is expensive and time-consuming. Speech emotion retrieval plays a large role in building generalized SER machine learning models, especially in the data collection process. Similar to other information retrieval systems, an effective speech emotion retrieval framework aims to achieve high-precision (e.g., reducing labor and financial costs for scalability) and high-recall (e.g., increasing data diversity for robust emotion representations) under different application domains. Therefore, the retrieval step serves as a fundamental basis for model construction, significantly influencing the quality of the collected data.

Specifically, some existing data collection pipelines rely on adopting various pre-trained SER classifiers to retrieve emotional speech samples to gather large-scale datasets. These models typically use different types of acoustic features and model architectures, and are ensembled via union and intersection of their prediction results for better recall and/or precision. However, these classification models are grounded from the same training resources, which inevitably limits their retrieval diversity (e.g., recall performance) for covering different out-of-domain (OOD) samples or finer emotion expressions. For instance, in these previous systems, it is not possible to explicitly retrieve shouting (hot-anger) versus displeased (cold-anger) sounds from the classification output. In addition, the growing number of ensemble models increases the computational requirements, leading to expensive and non-scalable solutions.

It is natural for humans to express their emotions in a diverse way, and natural language provides a mean to describe them. Further, language descriptions are agnostic toward distinct acoustic environments, which has potential to benefit OOD retrieval performance. Therefore, building a customizable speech emotion retrieval framework driven by natural language is key for an improved system. Therefore, according to various embodiments disclosed herein, this disclosure provides a way to retrieve speech emotion samples via natural language, which leverages powerful large language models (LLMs) such as ChatGPT as an anchor to search the matched audio-emotion patterns by inputting simple language prompts. Specifically, the methods and systems herein adopt the contrastive language-audio pre-training (CLAP) model as the backbone framework training with curated emotion captions, which is named herein as “CLAP4Emo.” In view of the lack of paired emotion captions in existing SER datasets, this disclosure provides a training strategy that utilizes a language model, such as a generative pre-trained transformer model or ChatGPT, for caption generation.

### Emotion Captions and Generation

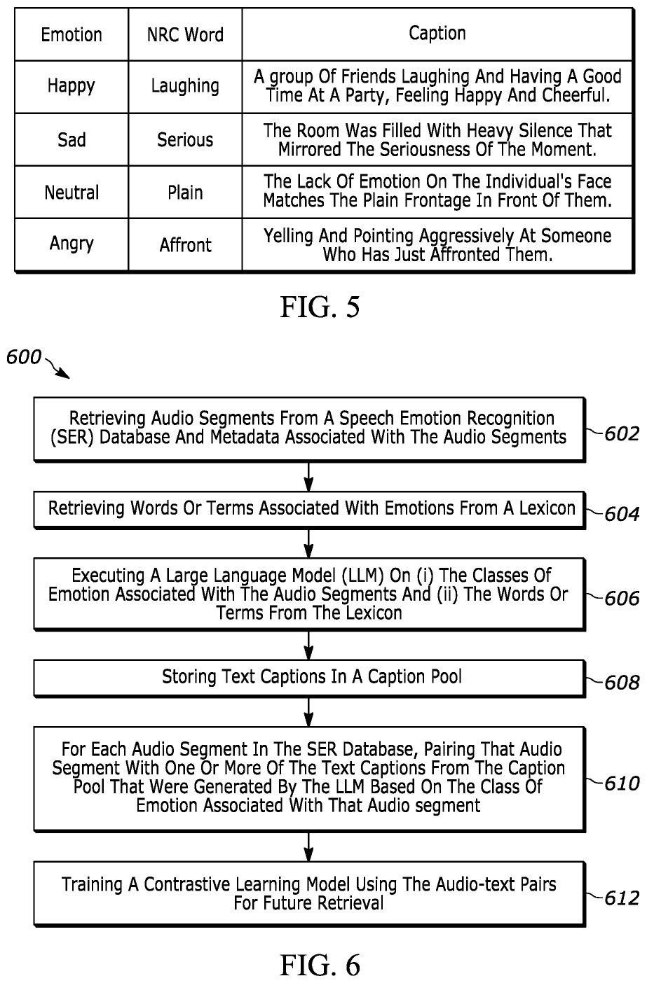

As mentioned above, training a CLAP model requires captions, which is not available in the existing SER datasets. Simple class label or using fixed template (e.g., “the emotion is <happy>”) descriptions only explores a very limited language space, restricting the capabilities of LLMs. Therefore, this disclosure proposes a scheme to leverage ChatGPT for emotion caption generation. The system instructs ChatGPT (or other large language model) to produce language descriptions for potential actions, behaviors, expressions, or any related scenarios of a given emotion. However, it may be too ambiguous and uncontrollable to generate meaningful captions by merely giving a general emotion description such as single word “angry”. Hence, this disclosure proposes utilizing an existing emotion lexicon, such as the National Research Council Canada's (NRC) emotion lexicon, to introduce hierarchical associations between the high-level emotion categories and their relative words (e.g., “angry-shouting”) for caption generation. Since lexicons contain large set of words and might be imbalanced across different emotions, additional filtering can be imposed by using a pre-trained text-based emotion classifier. The top-W most relevant words per emotion class according to their word-level prediction confidence are picked. FIG. 5 shows examples of the generated emotion captions.

### CLAP4Emo

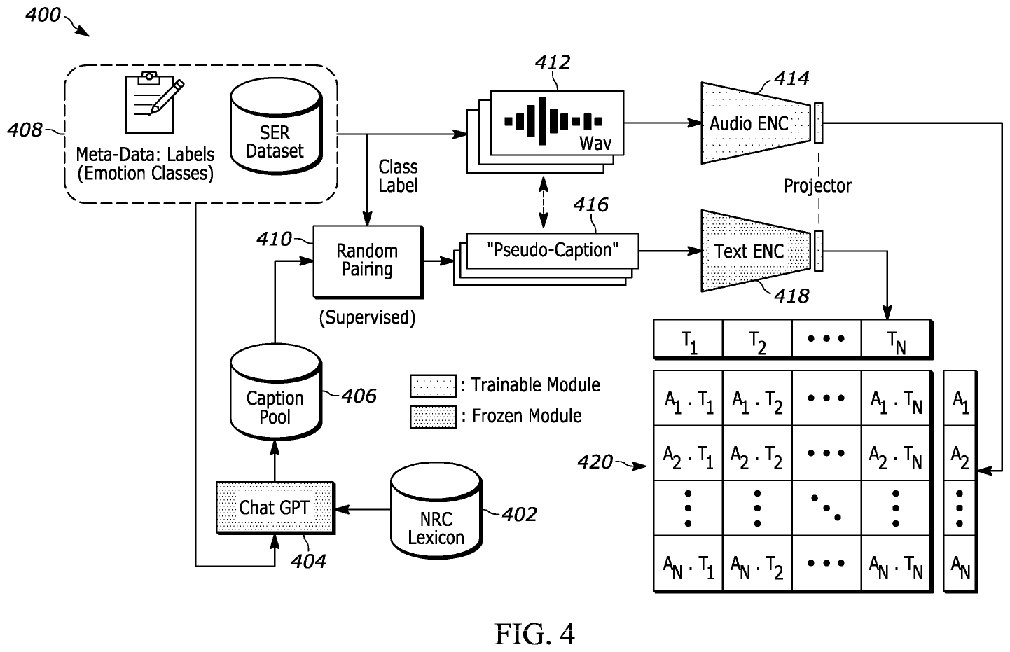

FIG. 4, which will be described further below, illustrates an overview of the proposed CLAP4Emo framework according to an embodiment. In this embodiment, a supervised random pairing strategy is performed to obtain the training audio-text pairs. The caption is drawn at random from the pool of ChatGPT-generated texts, taking into account the ground-truth emotion class label of the input audio data. The matching pair is re-sampled each training iteration. This strategy regularizes the model from overfitting to trivial pseudo details among the captions but still preserving the high-level emotion contexts, since the overall emotion stance of audio-text pairs are discriminative enough to be separated. For the CLAP training, the audio-text pairs are fed into their corresponding encoders to obtain utterance-level representations Aᵢ (audio) and Tᵢ (text). These encoders are flexible to utilize different types of neural architecture, such as Transformers or convolutional neural networks (CNNs). The symmetric cross-entropy loss is then computed to jointly train the full network along with their linear projections. The loss function aims to contrast the correct pairings of a batch of audio-text data (e.g., the diagonal pairs are considered as positives, others are negatives) from their dot-product similarities. Pre-trained LLMs (e.g., RoBERTa) and audio encoders (e.g., HuBERT) can be utilized to start as the model fine-tuning step instead of training the full network from scratch, which differs from the original CLAP framework. During the testing stage, the cosine similarity between the text embedding of an input prompt (e.g., output of the text encoder) and the audio embeddings (e.g., output of the audio encoder) can be calculated. The top-K most relevant samples are then retrieved as the final system outputs.

### FIGURES

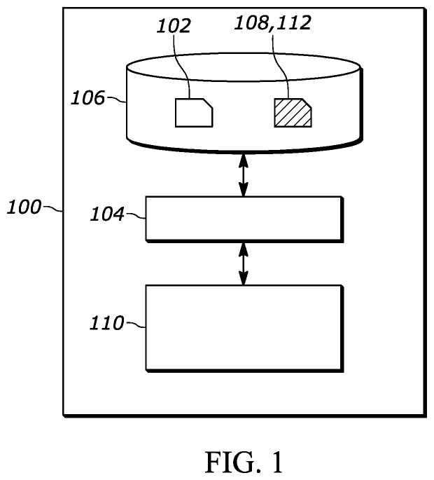

Machine learning and neural networks are an integral part of the inventions disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network: this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

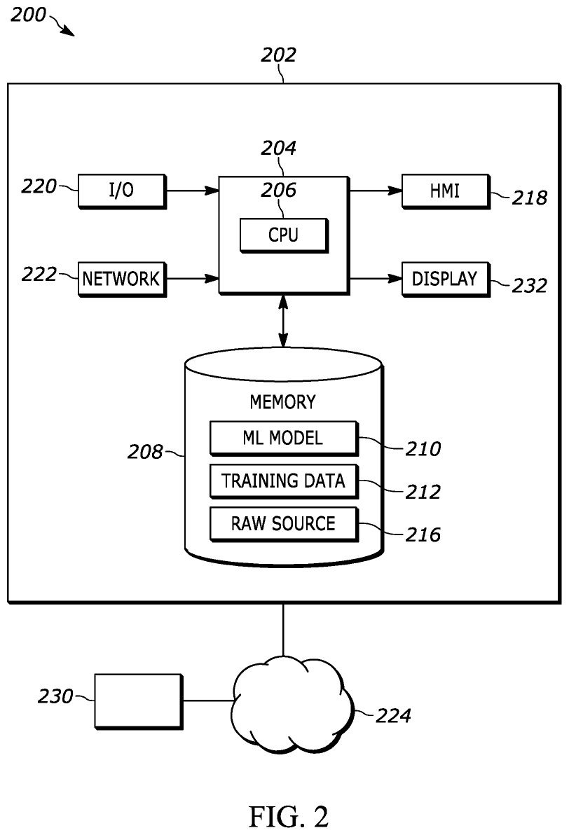

FIG. 2 depicts a system 200 to implement the machine-learning models described herein, for example the models in the CLAP4Emo framework and the contrastive learning models. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the ×86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured to identify an emotion based on the audio data of a human speaking. The machine-learning algorithm(s) 210 may include algorithms configured to operate one or more of the machine learning models described herein, including the models in the CLAP4Emo framework such as the contrastive learning model.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input audio that includes an utterance said by a human. The input audio may include various scenarios in which the utterances are made. The training dataset 212 may also include the text description of the utterance (e.g., “a group of people are laughing, feeling happy and cheerful”) that corresponds to the audio.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to retrieve emotions from an SER database, identify the presence of certain emotions in audio, annotate the occurrences, and the like. The machine-learning algorithm 210 may be programmed to process the raw source data 216 to identify the presence of the particular features. The machine-learning algorithm 210 may be configured to identify a feature in the raw source data 216 (e.g., audio) as a predetermined feature (e.g., yelling, screaming, laughing, whispering, etc.). The raw source data 216 may be derived from a variety of sources. For example, the raw source data 216 may be actual input data collected by a machine-learning system. The raw source data 216 may be machine generated for testing the system. As an example, the raw source data 216 may include raw audio from a microphone. And, as will be described further below with respect to the CLAP4Emo system, the raw source data 216 can be natural language text information associated with the scene (e.g., “a person is whispering very quietly and sound scared”).

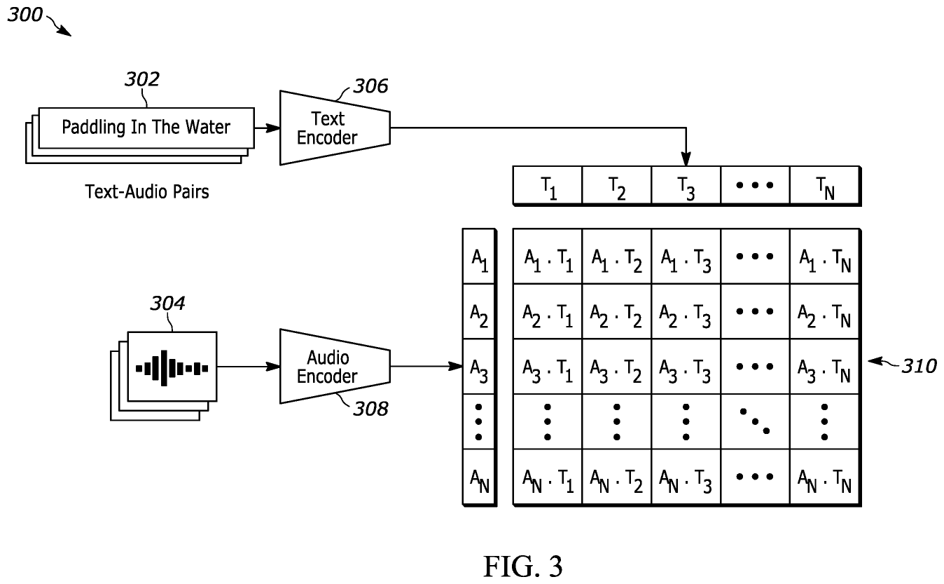

FIG. 3 illustrates a system 300 for executing contrastive language-audio pre-training (CLAP), according to an embodiment. The system 300 can be executed utilizing one or more components of the system 200, such as computing system 202 for example. The CLAP system receives, as input, both text 302 and audio segments 304, in pairs. Each text input can be a word, a phrase, or a sentence that is linked or paired with an associated audio segment. For example, a text input can be “paddling in the water” and a corresponding audio input can be an audio segment of the same.

CLAP leverages contrastive learning to create a joint multimodal space for audio and text descriptions. CLAP takes audio and text pairs, processes them through separate encoders, and brings their representations into a joint space using linear projections. In particular, CLAP uses two encoders—a text encoder 306 and an audio encoder 308—to connect language and audio representations. This method aims to enable zero-shot predictions without the need for predefined categories during training. Both representations are connected in joint multimodal space with linear projections. The space is learned with the (dis) similarity of audio and text pairs in a batch using contrastive learning, shown generally at 310.

In general, the contrastive learning provided herein in FIG. 3 and also FIG. 4 (below) can be performed as follows. Initially, both the audio and text data are processed separately through dedicated encoders, resulting in audio embeddings and text embeddings. These embeddings capture essential features or representations of the respective data. Several irrelevant or dissimilar text phrases and audio segments can also be fed into the encoders. The embeddings are projected into a joint space using learnable linear projections. This joint space is where the audio and text representations are compared and aligned. In the example shown, the text encoder produces a text-based vector having features T₁, T₂, T₃, . . . , T_{N} while the audio encoder produces an audio-based vector having features A₁, A₂, A₃, . . . , A_{N}. Once the embeddings are in the joint space, the model computes the similarity between the embeddings of audio-text pairs. Similarity can be measured using various metrics, such as cosine similarity or Euclidean distance. For instance, the model might assess how close or far apart the audio representation and its corresponding text representation are in this joint space. Contrastive learning employs a loss function that encourages the model to bring similar pairs closer while pushing dissimilar pairs apart. It calculates a loss based on the similarity between positive pairs (pairs of audio and text belonging together) and negative pairs (pairs that do not correspond to each other). This encourages the model to learn representations that make similar pairs more distinguishable from dissimilar pairs. The diagonal of the resulting matrix from this dot product shows paired audio and text according to their likely similarity, while the off-diagonal represent unpaired text and audio features (e.g., the sound of a person yelling and a text stating “a person is whispering”). The goal during training is to minimize this contrastive loss by adjusting the model's parameters (such as the encoders and projection layers). Through this process, the model learns to capture meaningful relationships between audio and text representations, effectively learning to associate relevant textual descriptions with corresponding audio signals.

Training a CLAP model requires captions, which are not available in SER datasets. For example, simple class labels sing a fixed template (“the emotion is <angry>”) descriptions explores only a very limited language space, which restricts the capabilities of LLMs. This disclosure therefore proposes methods and systems for leveraging a large language model (e.g., ChatGPT) for emotion caption generation. This not only decreases the time and resources otherwise required to generate labels, but also enables the unrestricted capabilities of LLMs rather than being constrained to a limited language space.

This CLAP system 300 is a type of contrastive learning model that compares text with audio, which is used as a backbone framework for training with curated emotion captions, which is named CLAP4Emo in this disclosure, and which is shown in FIG. 4 according to an embodiment.

FIG. 4 illustrates an embodiment of a system 400 for executing contrastive language-audio pre-training (CLAP) with curated emotion captions, referred to herein as CLAP4Emo. The system 400 is configured to generate data and train a machine learning model with the generated data in a more efficient manner than previous attempts, as explained above. This system can therefore be referred to as a system configured for training a contrastive language-audio model. Once again, the system 400 can be executed utilizing one or more components of the system 200, such as computing system 202 for example.

The system 400 relies upon a lexicon or caption database 402, for example the National Research Council (NRC) Canada Emotion Lexicon, developed by the National Research Council of Canada. This is a lexicon or a database containing words or terms associated with emotions. This resource aims to map words in natural language to specific emotions or affective states. The lexicon consists of a list of words along with their corresponding emotional categories or affective labels. Each word in the lexicon is tagged or categorized based on the emotions or affect it is associated with. For instance, words might be linked to emotions like happiness, sadness, anger, fear, disgust, surprise, etc. and are tagged as such. This lexicon provides a resource that can be used in various natural language processing (NLP) tasks, sentiment analysis, emotion detection, opinion mining, or other applications where understanding the emotional content of text is important, such as the system 400.

This stored lexicon 402 can be provided to, and relied upon by, a language model such as ChatGPT 404. This language model 404 can generate captions to store in a caption pool 406 using the lexicon 402 by establishing a hierarchical association between high-level emotion categories and their relative words (e.g., “angry-affront,” “happy-laughing,” “sad-serious”). These captions are not available in existing SER datasets, and thus enhance the system.

At 408, a speech emotion recognition (SER) database is provided, storing audio clips or speech segments, along with an associated emotion class for each clip or segment. In other words, each audio clip or segment also has an associated label indicating a class to which each audio clip or segment belongs to. For example, an audio segment of a person yelling “I hate you!” may be stored along with a label (stored as metadata associated with the audio) indicating “angry” as the emotion class. As another example, an audio segment of a person laughing may be stored in the SER database along with a label indicating “happy” as the emotion class. In embodiments, the label for each audio file may be ground-truth label, created by a human.

However, the stored emotion classes in the SER database 408 may be general and high-level. This is why the NRC lexicon 402 is also relied upon by the LLM (e.g., ChatGPT) 404 for generating captions. ChatGPT at 404 can rely on the emotion class from the SER database 408, along with associated words from the lexicon 402 to generate more specific, long-form captions. For example, for a specific audio segment from the SER database 408 of a person laughing, ChatGPT may generate a caption associated with that audio that says “a man is laughing very happily in a crowded room full of other people.” This caption is then stored in the caption pool 406 and is associated with the original audio file with its emotion class as “happy” from the SER database 408.

FIG. 5 illustrates some examples of generated emotion captions that can be output by the language model, e.g. ChatGPT 404. The model relies on an emotion from the metadata labels in the SER database 404, as well as a word from the NRC lexicon 402 to generate the captions. For example, with an emotion of “happy” and an NRC word of “laughing.” an example generated caption generated by ChatGPT 404 is “A group of friends laughing and having a good time at a party, feeling happy and cheerful.” Other examples are shown in FIG. 5. These captions are then stored in the caption pool 406 for training a CLAP model and utilization for random pairing 410 as describe above.

Returning to FIG. 4, at 410 the system performs a supervised random pairing strategy to obtain the training audio-text pairs. In embodiments, captions are drawn at random from the pool 406 of ChatGPT-generated texts, taking into account the ground-truth emotion class label of the input audio data stored in the SER database 408. Said another way, captions are retrieved from the caption pool 406 that were generated based on an emotion class from the SER database 408. This yields a pair of an audio segment as well as a caption (or pseudo-caption) from the caption pool 406 that was generated based on the emotion class label of that audio segment. The matching pair is re-sampled with each training iteration to provide multiple matching pairs. This strategy regularizes the model from overfitting to trivial pseudo details among the captions but still preserving the high-level emotion contexts, since the overall emotion stance of audio-text pairs are discriminative enough to be separated.

For each matching audio-text pair, the audio segments 412 are sent into an audio encoder 414, and the corresponding text captions 416 are sent into a text encoder 418. First, regarding the audio encoder 414, the audio segment can be preprocessed to be converted into a format suitable for analysis. This can include converting the audio signals into a spectrogram representation, such as Mel-frequency cepstral coefficients (MFCCs) or log Mel spectrograms. These representations capture the spectral features and temporal characteristics of the audio. The audio encoder 414 can then employ neural network architectures, such as convolutional neural networks (CNNs) or recurrent neural networks (RNNs), configured to process the preprocessed audio data and extract high-level features. For instance, a CNN might have layers that perform convolutions over the spectrogram input to capture hierarchical features like edges, textures, or patterns. The encoder layers learn to map the raw audio spectrogram or its processed representation into a lower-dimensional latent space where relevant information about the audio is captured. These learned representations aim to capture essential characteristics of the audio signal that are discriminative and informative for downstream tasks. The output of the audio encoder is a latent representation or embedding vector that represents the extracted features from the audio. This embedding vector encodes the audio's information in a condensed form (e.g., with reduced dimensions compared to the input spectrogram), making it suitable for comparison and learning in the joint multimodal space.

A projector may also be utilized which subjects the audio embeddings to further transformation through linear projection layers. These layers may adapt the embeddings to align better with the text embeddings in the joint multimodal space, enabling better comparison and learning across modalities.

Regarding the text encoder 418, this encoder is responsible for processing and encoding textual descriptions associated with audio data. Before encoding, the raw textual descriptions may be tokenized and preprocessed. Tokenization involves breaking down the text into individual tokens or words. Preprocessing may include lowercasing, removing punctuation, handling special characters, and possibly stemming or lemmatization to normalize the text. The text encoder 418 may then use techniques like word embeddings (e.g., Word2Vec, GloVe) or subword embeddings (e.g., Byte Pair Encoding, SentencePiece) to convert tokens into dense vector representations. These embeddings capture semantic relationships between words or subword units, enabling the model to understand the contextual meaning of the text. The text encoder 418 may leverage a transformer-based architecture like BERT (bidirectional encoder representations from transformers) or its variants. These models are pretrained using large text corpora and encode contextual information by considering the entire input sequence bidirectionally. The text encoder's layers process the word or subword embeddings, applying attention mechanisms and multiple transformer layers to capture the hierarchical and contextual information within the textual descriptions. This process results in a sequence of hidden representations for each token in the text. The output of the text encoder is a latent representation or embedding vector that encodes the information extracted from the textual descriptions. This embedding vector represents the text in a lower-dimensional space where semantically similar descriptions are closer together.

A projector may be utilized which subjects the text embeddings to further transformation through linear projection layers. These layers align the text embeddings with the audio embeddings in the joint multimodal space, facilitating better comparison and learning across modalities.

Contrastive learning then takes place at 420. A contrastive learning model can be employed in which, as shown in the example, the text encoder produces a text-based vector having features T₁, T₂, T₃, . . . , T_{N} while the audio encoder produces an audio-based vector having features A₁, A₂, A₃, . . . , A_{N}. Once the embeddings are in the joint space, the model computes the similarity between the embeddings of audio-text pairs. As explained above with reference to FIG. 3, the similarity can be measured using various metrics, such as cosine similarity or Euclidean distance. The model also employs a loss function that encourages the model to bring similar pairs closer while pushing dissimilar pairs apart. It calculates a loss based on the similarity between positive pairs (pairs of audio and text belonging together) and negative pairs (pairs that do not correspond to each other). This encourages the model to learn representations that make similar pairs more distinguishable from dissimilar pairs. The diagonal of the resulting matrix from this dot product shows pared audio and text according to their likely similarity, while the off-diagonal represent unpaired text and audio features (e.g., the sound of a person yelling and a text stating “a person is whispering”). The goal during training is to minimize this contrastive loss by adjusting the model's parameters (such as the encoders and projection layers). Through this process, the model learns to capture meaningful relationships between audio and text representations, effectively learning to associate relevant textual descriptions with corresponding audio signals. The results of the contrastive learning at 420, the pseudo captions 416, and/or the audio files 412 can be stored as training data 212. Thus, the system 400 provides an optimum system for generation of training data for easy retrieval.

FIG. 6 illustrates a method of generating training data for training a contrastive language-audio machine-learning model, according to an embodiment. The method can be executed utilizing one or more components of the system 200, such as computing system 202 for example.

At 602, the computing system retrieves audio segments from a SER database, such as the SER database 408 shown in FIG. 4. This also includes retrieving metadata associated with each audio segment. The metadata for each audio segment includes a class of emotion associated with that audio segment. For example an audio segment could include the sound of a person yelling, and the associated class of emotion retrieved can be “angry.” Both the audio segment and the labeled emotion can be retrieved.

At 604, the computing system retrieves words or terms associated with emotions from a lexicon, such as the NRC lexicon 402 shown in FIG. 4. As explained above, each word in the lexicon is tagged or categorized based on the emotions or affect it is associated with. For instance, words might be linked to emotions like happiness, sadness, anger, fear, disgust, surprise, etc. and are tagged as such.

At 606, a large language model (LLM) such as ChatGPT is executed on: (1) the classes of emotion associated with the audio segments retrieved from 602, and (2) the words or terms from the lexicon retrieved from 604. The words or terms retrieved from the lexicon can be based on the class of emotion. For example, if a labeled class of emotion of a particular audio segment is “happy,” the lexicon word retrieved can be “laughing” because the lexicon associates the word “laughing” with “happy.” The LLM such as ChatGPT would then generate captions based on these pairs of emotion descriptions from the metadata and words from the lexicon. Given the example of “happy” and “laughing,” the LLM may generate a caption such as “A group of friends are laughing and having a good time at a party, feeling happy and cheerful.” This process repeats for each emotion from the SER database, and each associated word retrieved from the lexicon.

At 608, each caption generated by the LLM is stored in storage. This can be referred to as a caption pool, or a stored pool of captions.

At 610, for each audio segment retrieved from the SER database, the computing system pairs that audio segment with one or more of the text captions stored in the caption pool that was/were generated by the LLM based on the class of emotion associated with that audio segment. For instance, continuing with the example of “happy” and “laughing,” the audio segment associated with the “happy” labeled class of emotion is paired with the caption “A group of friends are laughing and having a good time at a party, feeling happy and cheerful.” The same process continues for each audio file retrieved, pairing that audio file with the generated captions that were generated based on that audio file's metadata label.

At 612, the computing system trains a contrastive learning model using the audio-text pairs from 610. This generates trained audio encoder 414 and text encoder 418 shown in FIG. 4 for future retrieval. This provides a way to retrieve speech emotion samples via natural language. For example, if one desired to retrieve particular emotion type such as “happy” from any existing speech utterances, one can merely input a free-form natural language descriptions (e.g., “laughing loudly”) and the system can measure the cosine similarities between the extracted embeddings from trained encoders to retrieve the top most relevant speech files that match the given emotion descriptions.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for generating training data for training a contrastive language-audio machine-learning model, the method comprising:
retrieving a plurality of audio segments from a speech emotion recognition (SER) database and metadata associated with the audio segments, wherein the metadata of each audio segment includes a class of emotion associated with that audio segment;
retrieving words or terms associated with emotions from a lexicon;
executing a large language model (LLM) on (i) the classes of emotion associated with the audio segments and (ii) the words or terms from the lexicon, wherein the execution of the LLM generates a plurality of text captions associated with emotion;
storing the plurality of text captions in a caption pool;
for each audio segment retrieved from the SER database, pairing that audio segment with one or more of the text captions from the caption pool that were generated by the LLM based on the class of emotion associated with that audio segment, wherein the pairing yields audio-text pairs; and
training a contrastive learning model using the audio-text pairs.

2. The method of claim 1, further comprising:
executing a text encoder on the text caption of each audio-text pair to output a text-based vector with encoded information extracted from the text caption; and
executing an audio encoder on the audio segment of each audio-text pair to output an audio-based vector with encoded information extracted from the audio segment.

3. The method of claim 2, further comprising:
projecting the text-based vector and the audio-based vector to align the encoded information extracted from the text caption with the encoded information extracted from the audio segment, wherein the projecting yields projected audio-text pairs.

4. The method of claim 3, wherein the executing the contrastive learning model is on the projected audio-text pairs.

5. The method of claim 1, further comprising:
outputting a trained machine learning model configured to retrieve audio based on natural language text captions.

6. The method of claim 1, wherein the LLM is ChatGPT.

7. The method of claim 1, wherein the contrastive learning model is configured to execute a dot product to evaluate similarities between the audio-text pairs, and to push apart dissimilarities between the audio-text pairs.

8. The method of claim 1, wherein the lexicon is the National Research Council (NRC) Canada Emotion Lexicon.

9. The method of claim 1, wherein the words or terms retrieved from the lexicon are associated with the class of emotion.

10. A system for generating training data for training a contrastive language-audio machine-learning model, the system comprising:
a processor; and
memory storing instructions that, when executed by the processor, cause the processor to perform the following:
retrieving a plurality of audio segments from a speech emotion recognition (SER) database and metadata associated with the audio segments, wherein the metadata of each audio segment includes a class of emotion associated with that audio segment;
retrieving words or terms associated with emotions from a lexicon;
executing a large language model (LLM) on (i) the classes of emotion associated with the audio segments and (ii) the words or terms from the lexicon, wherein the execution of the LLM generates a plurality of text captions associated with emotion;
storing the plurality of text captions in a caption pool;
for each audio segment retrieved from the SER database, pairing that audio segment with one or more of the text captions from the caption pool that were generated by the LLM based on the class of emotion associated with that audio segment, wherein the pairing yields audio-text pairs; and
training a contrastive learning model using the audio-text pairs.

11. The system of claim 10, wherein the instructions, when executed by the processor, cause the processor to perform the following:
executing a text encoder on the text caption of each audio-text pair to output a text-based vector with encoded information extracted from the text caption; and
executing an audio encoder on the audio segment of each audio-text pair to output an audio-based vector with encoded information extracted from the audio segment.

12. The system of claim 11, wherein the instructions, when executed by the processor, cause the processor to perform the following:
projecting the text-based vector and the audio-based vector to align the encoded information extracted from the text caption with the encoded information extracted from the audio segment, wherein the projecting yields projected audio-text pairs.

13. The system of claim 12, wherein the executing the contrastive learning model is on the projected audio-text pairs.

14. The system of claim 10, wherein the instructions, when executed by the processor, cause the processor to perform the following:
outputting a trained machine learning model configured to retrieve audio based on natural language text captions.

15. The system of claim 10, wherein the LLM is ChatGPT.

16. The system of claim 10, wherein the contrastive learning model is configured to execute a dot product to evaluate similarities between the audio-text pairs, and to push apart dissimilarities between the audio-text pairs.

17. The system of claim 10, wherein the lexicon is the National Research Council (NRC) Canada Emotion Lexicon.

18. The system of claim 10, wherein the words or terms retrieved from the lexicon are associated with the class of emotion.

19. A non-transitory computer-readable medium storing instructions that, when executed by a processor, cause the processor to:
retrieve a plurality of audio segments from a speech emotion recognition (SER) database and metadata associated with the audio segments, wherein the metadata of each audio segment includes a class of emotion associated with that audio segment;
retrieve words or terms associated with emotions from a lexicon;
execute a large language model (LLM) on (i) the classes of emotion associated with the audio segments and (ii) the words or terms from the lexicon, wherein the execution of the LLM generates a plurality of text captions associated with emotion;
store the plurality of text captions in a caption pool;
for each audio segment retrieved from the SER database, pair that audio segment with one or more of the text captions from the caption pool that were generated by the LLM based on the class of emotion associated with that audio segment, wherein the pairing yields audio-text pairs; and
train a contrastive learning model using the audio-text pairs.

20. The non-transitory computer-readable medium of claim 19, wherein the instructions, when executed by the processor, further cause the processor to:
train the contrastive learning model using the audio-text pairs until convergence, and
output a trained machine learning model based on the convergence, wherein the trained machine learning model is configured to retrieve audio based on natural language text captions.
